(19) United States
(12) Patent Application Publication
(10) Pub. No.: US 2012/0059538 A1
(43) Pub. Date: Mar. 8, 2012

(54) CLOSED-LOOP SPEED AND TORQUE DAMPING CONTROL FOR HYBRID AND ELECTRIC VEHICLES

(75) Inventor: Robert L. Morris, Milford, MI (US)

(73) Assignee: GM GLOBAL TECHNOLOGY OPERATIONS LLC, Detroit, MI (US)

(21) Appl. No.: 13/024,441

(22) Filed: Feb. 10, 2011

Related U.S. Application Data
(60) Provisional application No. 61/380,352, filed on Sep. 7, 2010.

(51) Int. Cl. B60L 15/20; G06F 17/00

(52) U.S. Cl. 701/22; 180/65.6; 180/65.285; 903/902

(57) ABSTRACT

A method for minimizing driveline disturbances in a vehicle includes using a controller to automatically combine a damping torque control command with a motor speed control command in a closed loop to prevent a perceptible discontinuity in an applied motor torque during a change in transmission gear states. The method may include calculating error values in the rotational speeds of one or two traction motors, and using the calculated error value(s) to determine a required damping torque. The controller can multiply the error value for one traction motor by a gain value of the other traction motor before determining the required damping torque. A vehicle includes first and second traction motors, a transmission, and a controller. The transmission is powered by the traction motors, and the controller combines a damping torque control command with motor speed control command to prevent a discontinuity in an applied motor torque as noted above.

### CROSS-REFERENCE TO RELATED APPLICATIONS

This application claims the benefit of U.S. Provisional Patent Application No. 61/380,352, filed Sep. 7, 2010, which is hereby incorporated by reference in its entirety.

### TECHNICAL FIELD

The present invention relates to a method and a control system for implementing closed-loop motor speed control in conjunction with closed-loop damping of driveline oscillations in a vehicle.

### BACKGROUND

Hybrid electric vehicles (HEV) can selectively utilize an internal combustion engine and one or more high-voltage traction motors as alternate or concurrent power sources to optimize fuel efficiency. That is, an HEV having a full hybrid powertrain can be electrically propelled via the traction motor(s) at least some of the time, usually immediately upon starting the HEV and while operating below a threshold vehicle speed. One or more traction motors may alternately draw power from and deliver power to an energy storage system as needed. Upon launch of the vehicle or when operating above the threshold speed, the engine can be restarted using one of the traction motors or an auxiliary starter motor, and then quickly engaged with a transmission input member.

Various hybrid powertrains manage the torque output of the prime movers, i.e., a traction motor(s) and an internal combustion engine. Driveline vibrations in such vehicles can vary in severity. Typically, driveline vibrations are minimized by cancelling torque oscillations at a specific frequency or range of frequencies determined using the present gear ratio. Torque cancellation typically includes passing driveline inputs through signal conditioning filters, which can slow overall system responsiveness. Engine speed is used as a single feedback variable to command a single control signal, e.g., engine torque. However, single variable feedback/control schemes may provide inadequate vibration damping in a vehicle having multiple prime movers.

Another approach to solving driveline vibration in an HEV, or alternatively in a battery electric vehicle, includes using active driveline damping. In such an approach, desired powertrain and driveline operating states are determined, and a motor damping torque is calculated and added to a commanded motor torque in a manner that varies with the transmission operating mode. Damping and speed control are typically “decoupled” with respect to each other, i.e., the gains required for damping and speed control are separately calibrated and applied.

### SUMMARY

A method is disclosed herein for controlling the speed and damping of a vehicle using an integrated closed-loop approach. Damping control and speed control have different purposes. As used herein, damping control is intended to reduce transient driveline oscillations before they can reach the drive wheels of the vehicle. Speed control is intended to maintain a particular rotating part at a target speed, e.g., idling of the engine at 700 RPM or tracking of a desired slip in a particular clutch through a shift event. In certain modern transmissions having an increased level of complexity, the decoupled damping and speed control approach can produce discontinuities in the applied motor torque during a change in gear state. The present approach therefore couples or combines elements of speed control and damping control in the same component.

The present method uses proportional-integral (PI) control, i.e., a proportional gain in parallel with an integrator for the part being controlled. The proportional gain provides a relatively fast error response, while the integrator drives the system to zero steady-state error, as these terms are understood in the art. The method minimizes driveline disturbances due to switching gains in a vehicle having a PI controller by applying the integral gains before the integrators for a first and second traction motor. That is, damping torque provides the proportional gain for speed control, while an integrator for the part being controlled receives a separate command. The damping and speed control torques are designed together so that the damping torque does not “fight” a separate speed control PI, e.g., when damping torque is in one direction and speed control torque is in the other direction.

In particular, a method is provided for minimizing driveline disturbances in a vehicle having a controller and a transmission powered by at least one fraction motor. The method includes detecting a change in gear states of the transmission, and automatically combining a damping control torque with a motor speed control torque in a closed loop, via the controller, to prevent a perceptible discontinuity in an applied motor torque from the at least one traction motor during the change in gear state.

The method may include calculating the motor speed control torque using a proportional gain value from the damping control torque. Automatically combining the damping torque control with the motor speed control torque may include calculating an error value in the rotational speed of the at least one traction motor, and then using the calculated error value to determine a required damping torque for providing the damping control torque.

When two traction motors are used, the method may include multiplying the calculated error value for one of the traction motors by a gain value of the other traction motor before determining the required damping torque.

The method may further include receiving a set of desired targets, including at least one of an actual engine torque of the engine, a desired axle torque of the axle, wheel speeds of the vehicle's drive wheels, a desired input speed of the transmission, and desired clutch speed of the clutch. A desired operating state is then calculated for the traction motor(s), and the controller outputs a set of reference signals for each of the desired operating states. The reference signals may include a calibrated reference value for one or more of a damper torque from an input clutch, the axle torque, motor speed, transmission output speed, and engine speed.

The method may also include calculating a speed control torque signal for the at least one traction motor using a motor speed torque (MST) control block of the controller, and calculating a motor damping torque signal for the at least one traction motor using a motor damping torque (MDT) control block of the controller. The speed control torque signal and the motor damping torque signal are then combined to generate a total motor control torque for the at least one traction motor. The total motor control torque may be processed through a vehicle driveline model to generate an estimated damper torque for the input clutch, an estimated axle torque for the axle, and an estimated wheel speed for the drive wheels. The method may then include feeding the estimated damper torque, the estimated axle torque, and the estimated wheel speed back to the MDT control block as inputs to the MDT control block.

A vehicle as set forth herein includes at least one traction motor, a transmission powered by the traction motors, and a controller configured to execute the method noted above, and to thereby automatically combine a damping torque control command with the proportional (P) portion of a proportional integral (PI) motor speed control command. In the various embodiments, the integral gains are applied before the integrators for the traction motor(s) to prevent a discontinuity due to switching gains in an applied motor torque, e.g., during a change in gear states of the transmission. In other words, the integral gains are applied pre-gain to the integrators for the traction motors, which helps smooth out disturbances caused by gain changes during the change in gear state.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having a closed-loop speed controller as set forth herein;

FIG. 2 is block diagram for control logic executable by the controller of the vehicle shown in FIG. 1; and

FIG. 3 is a flow chart describing a gain multiplying approach of the control logic shown in FIG. 2.

### DESCRIPTION

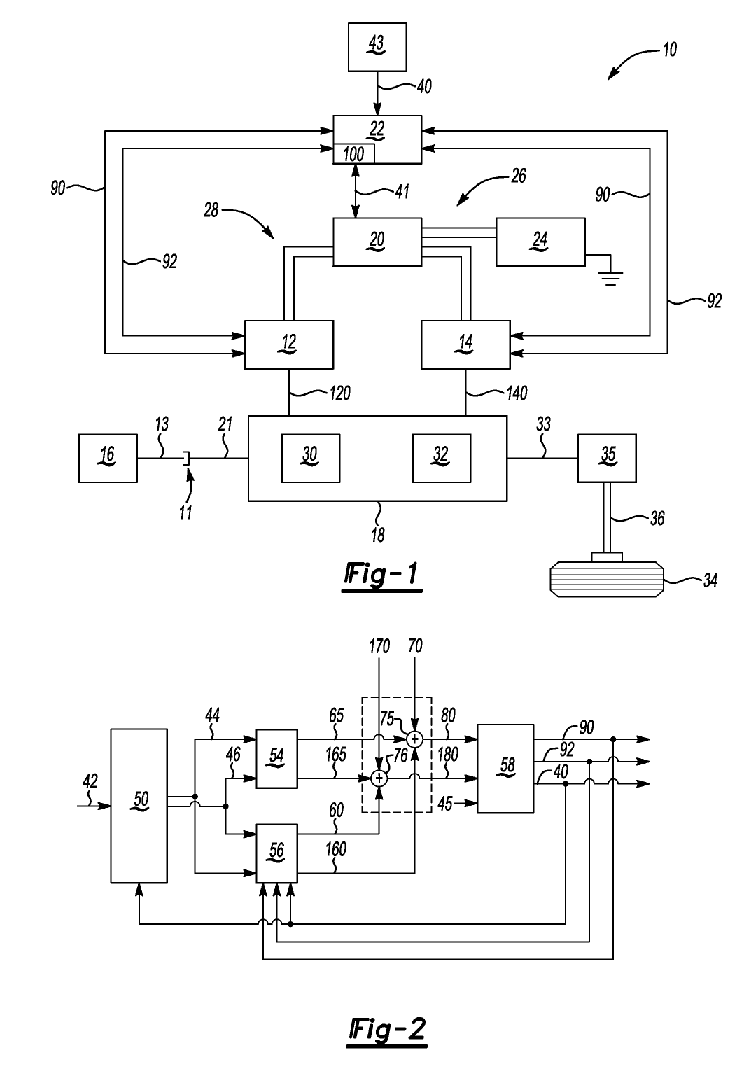

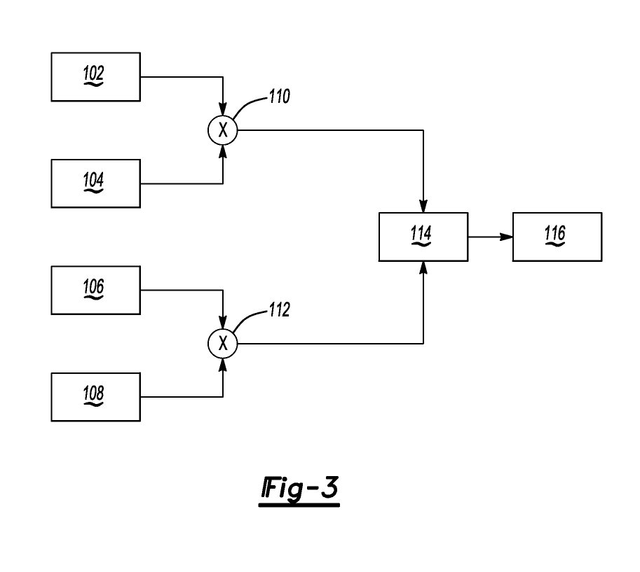

Referring to the drawings, wherein like reference numbers correspond to like or similar components throughout the several figures, a vehicle 10 is shown in FIG. 1 having a transmission 18. The transmission 18 receives input torque from multiple on-board torque generating devices. The torque generating devices may include an internal combustion engine 16 and/or one or two electric traction motors 12, 14, with the actual number of traction motors depending on the vehicle design. Such a design may be a parallel hybrid as shown in one embodiment, a series hybrid, or another design. A motor controller 22 having control logic 100 provides closed-loop motor speed control in conjunction with closed-loop control of a driveline damping torque from the traction motor(s) 12, 14, as set forth in detail below with reference to FIGS. 2 and 3.

Using the control logic 100 shown in FIG. 2, the controller 22 automatically combines damping torque control with motor speed control in a closed loop to prevent occurrence of a perceptible discontinuity in applied motor torque during a change in gear states of the transmission 18. The present approach therefore addresses a shortcoming in certain existing control designs which separately calibrate gain values for driveline damping torque and motor speed control, and avoids the potential conflict between the two different commands.

That is, proportional integral (PI) control is provided in existing systems, with the PI control values determined directly using the speeds which are being controlled. Such systems typically use input speed to a transmission and various clutch slip speeds as feedback variables in calculating the required control torques. The present approach instead calculates errors in the speeds of the various traction motors, and uses these calculated error values to determine the required control torques.

In existing systems, each motor speed that is being controlled typically has its own integrator within a PI control scheme, where the input to the integrator is given a desired speed profile or target speed, minus a measured or derived speed. The error is integrated and multiplied by gains that map a given integrator output to motor torques for different drive motors. This control approach can result in providing output torque when none is desired, as well as speed errors in the drive motors. Post-gaining of the integrator can also aggravate any discontinuities due to a change in gear state. By contrast, the present controller 22 and its control logic 100 provide an indirect control method which combines motor speed and damping torque in an integrated control approach.

Still referring to FIG. 1, the transmission 18 includes an input member 21 and an output member 33. Within the transmission 18, one or more planetary gear sets 30 and clutches 32 are used to transfer torque to the output member 33 in a manner dependent upon a presently commanded gear state or operating mode. Clutches 32 may be hydraulically-actuated devices in one possible embodiment. The transmission 18 may include as many planetary gear sets 30 and clutches 32 as are needed to provide the desired range of output speeds, e.g., three or more planetary gear sets 30 and four or more clutches 32 in one embodiment.

The vehicle 10 of FIG. 1 may be a hybrid electric vehicle (HEV) or a battery electric vehicle (BEV) according to two possible configurations. Again, the HEV may be a parallel or a series hybrid design. Engine 16 may be selectively connected to the transmission 18 via an input clutch 11. Input clutch 11 thus permits selective engagement of a crankshaft 13 of engine 16 with the input member 21 of transmission 18 in certain drive modes, and may include transient torque damping structure, e.g., a damping mechanism and spring which damp any pulses from the engine connection, especially during engine start/stop events. In an HEV or BEV configuration, fraction motor 12 can provide motor torque via a motor shaft 120 at levels sufficient for propelling the vehicle 10. Traction motor 14 may be used in conjunction with traction motor 12 depending on the vehicle configuration, with a motor shaft 140 of motor 14 being connected directly to the driveline of the vehicle 10 in some transmission embodiments.

Traction motors 12 and 14 are each configured as multi-phase permanent magnet/AC induction-type electric machines, which may be individually rated for approximately 60 VAC to approximately 300 VAC or more depending on the vehicle design. Motors 12, 14 are electrically connected to an energy storage system (ESS) 24 via a high-voltage DC bus bar 26, a traction power inverter module (TPIM) 20, and a high-voltage AC bus bar 28. The ESS 24 is a battery or other rechargeable energy storage device which can be selectively recharged using motor torque from either or both of the motors 12, 14 when the motors are actively operating as generators, e.g., by capturing energy during a regenerative braking event.

Motor torque from either or both of the traction motors 12 and 14 is transmitted to their respective motor shafts 120 and 140, each of which is connected to various members of one or more planetary gear sets 30 of transmission 18. Multiple braking and/or rotating clutches 32 are also provided within the transmission 18 to selectively transfer torque from motors 12 and/or 14, and/or from a crankshaft 13 of the engine 16, to an output member 33 of the transmission. The output member 33 of transmission 18 is ultimately connected to drive wheels 34 of the vehicle 10 through an axle 36 and a final gear set 35.

The vehicle 10 includes the TPIM 20, which is a power inverter and control device configured to receive motor control commands 41 from the controller 22. Controller 22 may be electrically connected to each of the traction motors 12 and 14, and adapted for receiving raw speed data 40 from various speed sensors 43 positioned as needed throughout the vehicle 10, e.g., on the axle 36, motor shafts 120, 140, input member 21, etc. Controller 22 controls the motor speed, operating mode, and power flow to and from the motor(s) and other electrical devices aboard the vehicle 10.

The controller 22 uses control logic 100 to automatically control torque output from the traction motors 12 and 14 through the transmission 18 to the axle 36. Control logic 100 automatically combines damping torque and speed control of the motors 12, 14. This helps to prevent a perceptible discontinuity in applied torque during a change in gear states of transmission 18. Thus, speed control is combined with damping control as part of an integrated system, and a fundamental change occurs from using error values from speed integrators for input speed and clutch speed to using error values from speed integrators for motors 12 and 14 in a closed loop. This eliminates steady-state error in the motor speeds in an approach that will now be described with reference to FIGS. 2 and 3.

Referring to FIG. 2, the control logic 100 includes various logic blocks 50, 54, 56, and 58. A desired dynamics block 50 receives a set of desired targets (arrow 42), such as actual engine torque, desired axle torque, wheel speed, and desired input speed and clutch speeds to the transmission 18. These values may be determined based upon operator inputs, e.g., force applied to an accelerator pedal, position of a transmission gear selector, status of a vehicle braking system, speed control setting, and/or other suitable operator inputs. The inputs to desired dynamic block 50 are used to determine a desired operating state for each of the torque-generating devices used aboard vehicle 10 in terms of reference parameters or signals 44 for the various operating states.

Desired dynamics block 50 determines reference signals (arrow 44) and passes through measured speed (arrow 46). Reference signals (arrow 44) may include a calibrated reference value for each of a damper torque, i.e., from input clutch 11, axle torque, speeds for the traction motors 12 and 14, transmission output speed, and engine speed. Measured speeds (arrow 46) can include speeds of both motors 12 and 14.

Reference signals (arrow 44) and measured speeds (arrow 46) are fed forward to a motor speed torque (MST) control block 54 and a motor damping torque (MDT) control block 56. With respect to the MST control block 54, this block calculates speed control torque signals 65, 165 for the respective motors 12 and 14. These values are fed forward to different summation nodes 75 and 76 as shown. At the same time, the MDT control block 56 separately calculates damping torque signals 60, 160 for the respective motors 12 and 14. The speed control torque signal 65 arrives at the same summation node as the damping torque signal 160, i.e., node 75, such that the torque signal for speed control of motor 12 is combined with the torque signal for damping torque of motor 14. Likewise, the speed control torque signal 165 arrives at the same summation node as the damping torque signal 60, i.e., node 76, such that the torque signal for speed control of motor 14 is combined with the torque signal for damping torque of motor 12.

In the dotted line box 95, open loop torque commands 70 and 170 are also input to the respective summation nodes 75 and 76. The output of nodes 75 and 76 are a total motor control torque 80 for motor 12 and a total motor control torque 180 for motor 14. These torque values are fed forward to a driveline dynamic model block 58. Torque values 80 and 180 are then used by controller 22, in conjunction with other driveline dynamic control operations as needed, to control and manage vibration along the driveline of vehicle 10. Also fed into the driveline dynamic model block 58 are a set of system torques, e.g., engine torque, clutch torque, braking torque, accessory load, road load, etc.

Driveline model block 58 has different outputs determinable by the various dynamic forces acting on the driveline and known individual characteristics of the driveline, e.g., mass and inertial forces. The controller 22 thus calculates or otherwise determines various required feedback parameters, including an estimated damper torque 90 from input clutch 11 (see FIG. 1), an estimated axle torque 92, and estimated or measured speed data 40, e.g., for the wheels 34, traction motors 12 and 14, transmission output member 33, and engine 16. The values into and out of block 58 may be subjected to any required analog-to-digital or digital-to-analog conversion, filtering, calibration, and other required manipulations to attain a representative signal. The estimated damper torque 90, estimated axle torque 92, and estimated or measured speed data 40 are fed back to the MDT control block 56 as additional inputs to that block, and the estimated or measured speed data 40 is also fed back to the desired dynamics block 50.

In one embodiment, a first matrix can be formed by controller 22 comprising a single dimensional matrix or a vector containing a subset of the reference signals 44. A second matrix can be formed using the estimated damper torque 90, estimated axle torque 92, and estimated or measured speed 40. The second matrix may then be multiplied by a gain factor matrix to calculate a feedback matrix.

An individual gain factor matrix may be determined for each transmission operating mode. The gain factor matrices can be determined off-line and stored as calibration values for application as noted below. The first matrix can be input to the MDT control block 56 to communicate the reference signals 44 to the MDT control block. Likewise, the feedback matrix can communicate the feedback estimated damper torque 90, estimated axle torque 92, and estimated or measured speed 40 to MDT control block 56. MDT control block 56 may then simultaneously solve a plurality of equations, e.g., using matrix algebra. The solved equations can be used to determine torques to be commanded from the traction motors 12 and 14 based upon the operating state parameters contained in the first matrix and the feedback matrix.

Referring to FIG. 3, a flow chart generally explains the gain calculation and multiplication aspect of the control logic 100 shown in FIG. 2 and described above. Controller 22 calculates the speed error of traction motors 12 and 14 at steps 102 and 106, respectively. This may be done at error calculation block 54 of FIG. 2. Speed errors from steps 102 and 106 are then fed forward to respective multiplier nodes 110 and 112.

At step 104, the controller 22 calculates the gain for traction motor 14 required for controlling traction motor 12. This gain value is then fed forward to node 110, where it is multiplied with the error value from step 102. The output of node 110 is fed forward to node 114.

Step 108 calculates the required gain value for fraction motors 12 for controlling traction motor 14. This gain value is fed forward to node 112, where it is multiplied with the motor speed error value from step 106. The output of node 112 is fed forward to node 114. At node 116, the output values from nodes 110 and 112 are added together, and the resultant value can be used at step 116 to calculate the motor torque required for traction motor 12. A similar process can be used to calculate the motor torque required for traction motor 14.

As shown in FIG. 3, the gains are multiplied so that the calculated control torques and motor speeds are fully integrated. This avoids discontinuity in control torque as noted elsewhere above. Errors in motor speed for the traction motors 12 and 14 are used to calculate the motor control torques instead of using, for example, transmission input speed and/or clutch slip speed. The result is an improved vehicle drive quality wherein motor speed errors are driven to zero, thus optimizing gear shifts or state changes of transmission 18.

While the best modes for carrying out the invention have been described in detail, those familiar with the art to which this invention relates will recognize various alternative designs and embodiments for practicing the invention within the scope of the appended claims.

1. A method for minimizing driveline disturbances in a vehicle having a controller and a transmission powered by at least one traction motor, the method comprising:
detecting a change in gear states of the transmission; and
automatically combining a damping control torque with a motor speed control torque in a closed loop, via the controller, to prevent a perceptible discontinuity in an applied motor torque from the at least one traction motor during the change in gear state.

2. The method of claim 1, further comprising:
calculating the motor speed control torque using a proportional gain value from the damping control torque.

3. The method of claim 1, wherein automatically combining the damping torque control with the motor speed control torque includes calculating an error value in the rotational speed of the at least one traction motor, and then using the calculated error value to determine a required damping torque for providing the damping control torque.

4. The method of claim 3, wherein the at least one traction motor includes a first and a second traction motor, the method further comprising:
multiplying the calculated error value for one of the first and the second traction motor by a gain value of the other of the first and the second traction motor before determining the required damping torque.

5. The method of claim 1, wherein the vehicle includes an engine, an axle, drive wheels, and a clutch in the transmission, the method further comprising:
receiving a set of desired targets, including at least one of: actual engine torque of the engine, desired axle torque of the axle, wheel speeds of the drive wheels, desired input speed of the transmission, and desired clutch speed of the clutch;
calculating a desired operating state for the at least one traction motor; and
outputting, via the controller, a set of reference signals for each of the desired operating states.

6. The method of claim 5, wherein the vehicle includes an input clutch between the engine and the transmission, and wherein the reference signals include a calibrated reference value for: the damper torque from the input clutch, the axle torque, the speed of the at least one traction motor, the output speed of the transmission, and the speed of the engine.

7. The method of claim 6, further comprising:
calculating a speed control torque signal for the at least one traction motor using a motor speed torque (MST) control block of the controller;
calculating a motor damping torque signal for the at least one traction motor using a motor damping torque (MDT) control block of the controller; and
combining the speed control torque signal and the motor damping torque signal to generate a total motor control torque for the at least one traction motor.

8. The method of claim 7, further comprising:
processing the total motor control torque through a vehicle driveline model to thereby generate an estimated damper torque for the input clutch, an estimated axle torque for the axle, and an estimated wheel speed for the drive wheels; and
feeding the estimated damper torque, the estimated axle torque, and the estimated wheel speed back to the MDT control block as inputs to the MDT control block.

9. A vehicle comprising:
a traction motor;
a transmission powered by the traction motor; and
a controller configured to automatically combine a damping torque control command with a motor speed control command to thereby prevent a discontinuity in an applied motor torque from the traction motor during a change in gear states of the transmission.

10. The vehicle of claim 9, wherein the traction motor includes a first and a second traction motor, and wherein the controller automatically combines a damping torque control command with a motor speed control command for each of the first and the second traction motors.

11. The vehicle of claim 9, wherein the damping control torque provides a proportional gain for the motor speed control torque.

12. The vehicle of claim 9, wherein the controller is configured for automatically combining the damping torque control with the motor speed control in part by calculating error value in the rotational speed of the traction motor, and then using the calculated error value to determine a required damping torque for providing the damping control torque.

13. The vehicle of claim 12, wherein the traction motor includes a first and a second traction motor, and wherein the controller is configured for multiplying the calculated error value for the first traction motor by a gain value of the second traction motor before determining the required damping torque.

14. The vehicle of claim 13, further comprising an engine, an axle, drive wheels, and a clutch of the transmission, wherein the controller is configured for:
receiving a set of desired targets, including at least one of: actual engine torque of the engine, desired axle torque of the axle, wheel speeds of the drive wheels, desired input speed of the transmission, and desired clutch speed of the clutch;
calculating a desired operating state for each of the traction motors; and
outputting, via the controller, a set of reference signals for the desired operating state.

15. The vehicle of claim 14, further comprising an input clutch between the engine and the transmission, wherein the reference signals include a calibrated reference value for a damper torque from the input clutch.

16. The vehicle of claim 9, wherein the controller is configured for:
calculating a speed control torque signal for each of the motors using a motor speed torque (MST) control block;
calculating a motor damping torque signal for each of the motors using a motor damping torque (MDT) control block; and
combining the speed control torque signal and the motor damping torque signal to generate a total motor control torque for each of the motors.

17. The vehicle of claim 16, wherein the controller is configured for:
processing the total motor control torque for the motor through a vehicle driveline model to thereby generate an estimated damper torque for an input clutch of the vehicle, an estimated axle torque for an axle of the vehicle, and an estimated wheel speed for the wheels of the vehicle; and
feeding the estimated damper torque, the estimated axle torque, and the estimated wheel speed back to the MDT control block as inputs to the MDT control block.

18. A method for minimizing driveline disturbances in a vehicle having a controller and a transmission powered by a first and a second traction motor, the method comprising:
detecting a change in gear states of the transmission; and
automatically combining a damping control torque with a motor speed control torque in a closed loop, via the controller, for each of the first and the second traction motor, to prevent a perceptible discontinuity in an applied motor torque from the first and the second traction motor during the change in gear state;
wherein automatically combining a damping control torque includes calculating an error value in the rotational speed of the at least one traction motor, and then using the calculated error value to determine a required damping torque for providing the damping control torque.
